(19) United States
(12) Patent Application Publication
(10) Pub. No.: US 2001/0027440 A1
(43) Pub. Date: Oct. 4, 2001

(54) Method of electronic credit service

(76) Inventors: Shuichi Tanaka, Sagamihara (JP); Toshiyuki Ono, Kawasaki (JP); Toshiya Cho, Machida (JP); Tokuya Sugamiya, Yokohama (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/797,482

(22) Filed: Feb. 28, 2001

(30) Foreign Application Priority Data
Mar. 30, 2000 (JP) 2000-097815

(51) Int. Cl. G06F 17/60

(52) U.S. Cl. 705/39; 705/26

(57) ABSTRACT

The present invention provides an electronic credit service for shortening the process of checking a buyer's credit standing on the seller side and ensuring payment collection by the seller in electronic commerce. A method of electronic credit service according to the present invention stores each buyer's credit inspection result in a credit organization server, and upon receiving order information from a buyer client, an electronic commerce server transmits a request for a credit guarantee to the credit organization server. The credit organization server then performs a credit guarantee process on the order information from the buyer. The electronic commerce server transmits to the seller client the order information with a credit guarantee result attached thereto, and upon receiving an order reception result from the seller client, the electronic commerce server transmits the order reception result to the credit organization server and the buyer client.

### BACKGROUND OF THE INVENTION

The present invention relates to an electronic credit service using a communications network such as the Internet.

Types of conventional settlement means employed in electronic commerce include transfer of money to a bank account and credit card settlement, and one known technique for realizing credit card settlement on the Internet is SET (Secure Electronic Transaction), which is described on pages 52 through 57 of a book entitled “New Trends and Techniques in Internet Commerce” published by Kyoritsu Publishing Company.

In a credit card settlement system using SET, an electronic store receives from a customer such information as the contents of an order, the number of the customer's credit card, and its term of validity, and, based on the received information, the store makes an inquiry to the financial institution to verify the status of the credit card.

On the other hand, one conventional credit guarantee means for the trade finance EDI is a transaction using a letter of credit (L/C), which is described on pages 74 through 81 of “the Trade Finance EDI Execution Guideline” drafted by the Electronic Commerce Promotion Council of Japan (ECOM) in March 1999.

In the transaction using an L/C, after an import/export sales contract is concluded between a buyer and a seller, the buyer's bank has the buyer make a deposit in the bank for issuing the L/C at the request of the buyer. The amount of the deposit is equivalent to the transaction price. In return for the deposit, the bank guarantees the seller the payment.

As described above, in a credit card settlement system using SET in electronic commerce, an electronic store receives from a customer such information as the contents of an order, the number of the consumer's credit card, and its term of validity, and, based on the received information, the store makes an inquiry to the financial institution to verify the status of the credit card. Therefore, it is necessary to make the credit inquiry each time an order is received even though some of the orders received may have to be rejected as a result of the inquiry, increasing a burden on the seller.

In the transaction using an L/C for the trade finance EDI, the L/C is opened after an import/export sales contract is concluded. This means that it takes a little time for the seller to receive the L/C after supplying the order information, making it impossible for the seller to send the ordered goods until the seller receives the L/C. Thus, it is a waste of time to wait for the L/C to be sent, and, furthermore, it is necessary to compare the order information with the received L/C, also increasing a burden on the seller.

### SUMMARY OF THE INVENTION

In order to solve the above problems, it is an object of the present invention to provide an electronic credit service for shortening the process of checking a buyer's credit standing on the seller side and ensuring payment collection by the seller.

To achieve the above object, a method of electronic credit service according to the present invention basically stores each buyer's credit inspection result, and upon receiving order information from a buyer, the method attaches a credit guarantee or a credit insurance to the order information and transmits it to the seller in order to shorten the process of checking the buyer's credit standing on the seller side and ensure the payment collection by the seller. Preferably in the method, the buyer apparatus transmits to the mediating apparatus or the seller apparatus both information indicating an order and information indicating an inspection result of the buyer's solvency obtained by the credit organization. It should be noted that the inspection result may indicate the maximum amount which the buyer is capable of paying, or alternatively the inspection result may indicate whether the buyer can pay for the amount of each order.

Specifically, two methods of electronic credit service for ensuring payment collection by a seller in electronic commerce according to the present invention are configured as follows.

One method of electronic credit service for ensuring payment collection by a seller in electronic commerce performs a credit inspection to inspect a buyer's credit standing and executes a credit guarantee to ensure payment, and employs a credit organization server, an electronic commerce server, a buyer client, a seller client, and a communications network, wherein the credit organization server performs the steps of: receiving application information of credit inspection from the buyer client; performing a credit inspection process to check the buyer's credit standing based on the received application information of credit inspection; and transmitting a credit inspection result to the buyer client; and wherein the electronic commerce server performs the steps of: receiving order information from the buyer client; determining whether a credit guarantee is required based on a credit guarantee necessity field included in the received order information; if the credit guarantee necessity field indicates that no credit guarantee is required, transmitting to the seller client the order information with a credit guarantee result attached thereto which indicates that no credit guarantee process has been performed, receiving an order reception result from the seller client, and transmitting the received order reception result to the buyer client; and if the credit guarantee necessity field indicates that a credit guarantee is required, transmitting the order information and a request for the credit guarantee to the credit organization server; and wherein the credit organization server further performs the steps of: receiving the order information and the request for the credit guarantee from the electronic commerce server; performing a credit guarantee process based on the received order information and the received request for the credit guarantee; and transmitting a credit guarantee result to the electronic commerce server; and wherein the electronic commerce server further performs the steps of: receiving the credit guarantee result from the credit organization server; transmitting to the seller client the order information with the credit guarantee result attached thereto; receiving an order reception result from the seller client; and transmitting the received order reception result to the credit organization server and the buyer client; and wherein the credit organization server receives the order reception result from the electronic commerce server.

On the other hand, the other method of electronic credit service for ensuring payment collection by a seller in electronic commerce performs a credit inspection to inspect a buyer's credit standing and prepares a credit insurance to ensure payment, and employs a credit organization server, an electronic commerce server, buyer client, a seller client, and a communications network, wherein the electronic commerce server performs the steps of: receiving order information from the buyer client; determining whether a credit insurance is required, based on credit insurance necessity conditions registered by the seller client beforehand; if it is determined that no credit insurance is required, transmitting to the seller client the order information with credit insurance information attached thereto which indicates that no credit insurance has been prepared, receiving an order reception result from the seller client, and transmitting the received order reception result to the buyer client; and if it is determined that a credit insurance is required, transmitting the order information and a request for preparation of a credit insurance to the credit organization server; and wherein the credit organization server performs the steps of: receiving the order information and the request for the preparation of the credit insurance from the electronic commerce server; performing a credit insurance preparation process based on the received order information and the received request for the preparation of the credit insurance; and transmitting prepared credit insurance information to the electronic commerce server; and wherein the electronic commerce server further performs the steps of: receiving the credit insurance information from the credit organization server; transmitting to the seller client the order information with the credit insurance information attached thereto; receiving a credit insurance application result and an order reception result from the seller client; transmitting the received credit insurance application result to the credit organization server; and transmitting the received order reception result to the buyer client; and wherein the credit organization server receives the credit insurance application result from the electronic commerce server.

### BRIEF DESCRIPTION OF THE DRAWINGS

FIG. 1 is a flowchart showing the overall process performed by a first embodiment of the present invention.

FIG. 2 is a diagram showing the system configuration realizing the first embodiment and a second embodiment of the present invention;

FIG. 3 is a flowchart showing the details of the credit guarantee process employed by the first embodiment;

FIG. 4 shows an example of credit inspection application information;

FIG. 5 shows an example of credit inspection results;

FIG. 6 shows an example of order information;

FIG. 7 shows an example of credit guarantee results;

FIG. 8 shows an example of credit insurance information;

FIG. 9 is a flowchart showing the overall process performed by the second embodiment of the present invention; and

FIG. 10 is a flowchart showing the details of the credit insurance preparation process employed by the second embodiment.

### DETAILED DESCRIPTION OF THE INVENTION

Embodiments of the present invention will be described below with reference to accompanying drawings.

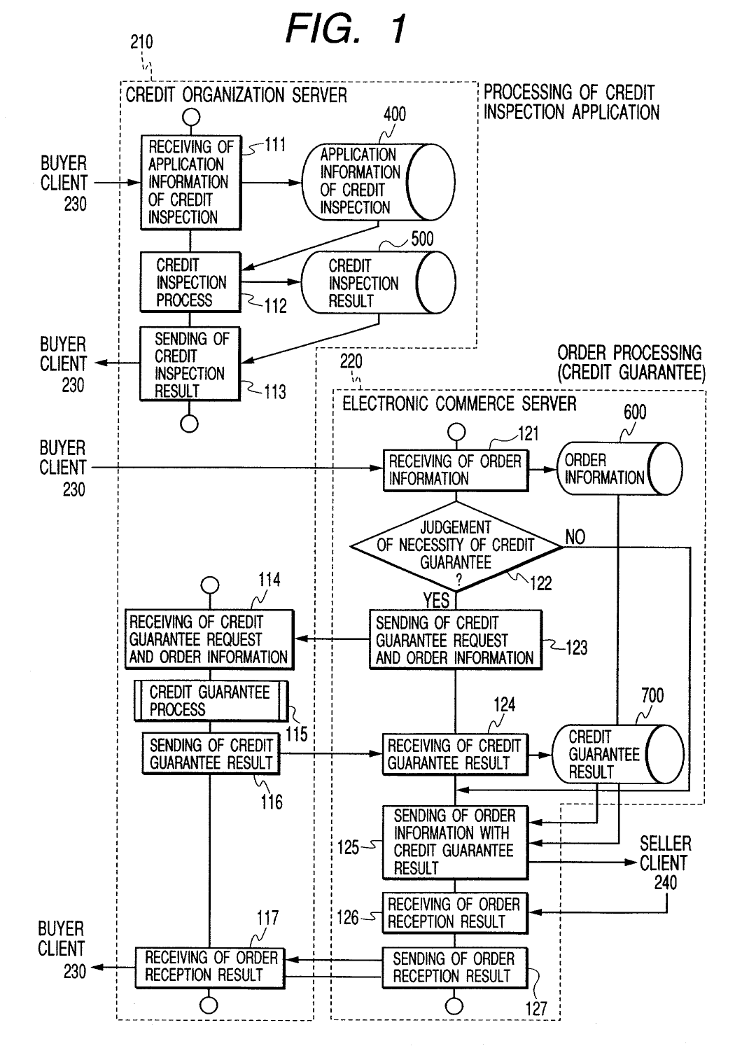

FIG. 1 is a flowchart showing the overall process for ensuring payment collection by a seller by use of a credit guarantee according to a method of electronic credit service of the first embodiment of the present invention.

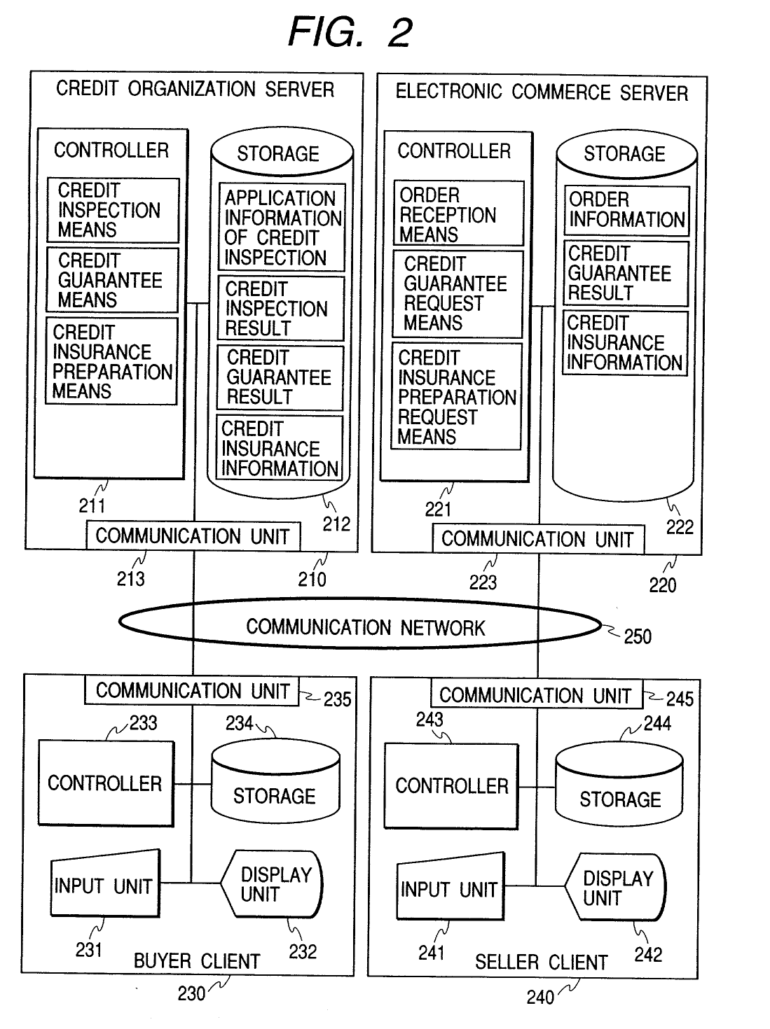

Description will be made of the configuration of an electronic credit service system shown in FIG. 2.

The electronic credit service system comprises a credit organization server 210, an electronic commerce server 220, a buyer client 230, a seller client 240, and a communication network 250 connecting the above servers and clients one another.

The credit organization server 210 is a computer comprising a controller 211, a storage 212, and a communication unit 213. The controller 211 includes a credit inspection means, a credit guarantee means, and a credit insurance preparation means, while the storage 212 stores application information of credit inspection, credit inspection results, credit guarantee results, and credit insurance information. The electronic commerce server 220 is a computer comprising a controller 221, a storage 222, and a communication unit 223. The controller 221 includes an order reception means, a credit guarantee request means, and a credit insurance preparation request means, while the storage 222 stores order information, credit guarantee results, credit insurance information. The buyer client 230 is a computer comprising an input unit 231, a display unit 232, a controller 233, a storage 234, and a communication unit 235. The seller client 240 is a computer comprising an input unit 241, a display unit 242, a controller 243, a storage 244, and a communication unit 245.

The credit organization server 210 and the electronic commerce server 220 each preferably have a computer whose processing capability is high enough to provide a plurality of buyer clients 230 and a plurality of seller clients 240 with service. They also preferably have a mass storage for storing information on various services and users. Specifically, they may be mainframe computers or high-performance workstations.

The buyer client 230 and the seller client 240, on the other hand, may be general computer systems connectable to a communications network. Specifically, they may be personal computers or TVs having a bi-directional communications function added thereto.

The communication network 250 can be any transmission medium transmitting information to another information processing apparatus.

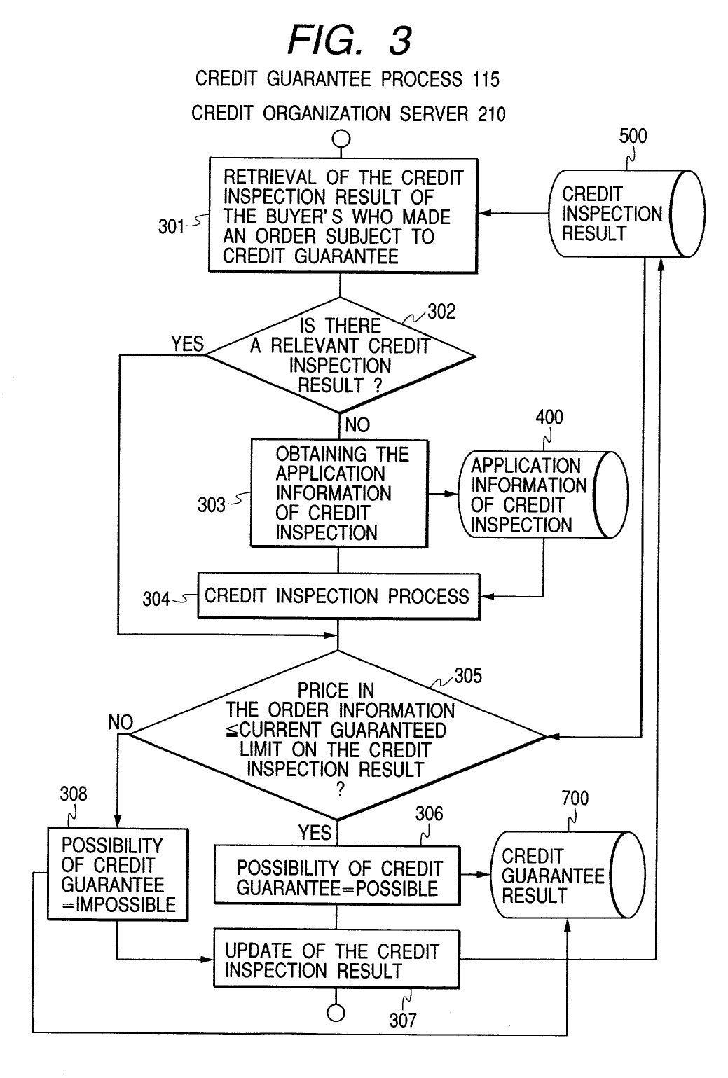

The process performed by the first embodiment will be described with reference to the overall process flowchart in FIG. 1 and the detailed process flowchart in FIG. 3 along with FIG. 2.

The credit inspection application process will be first described.

<Step 111> Credit Organization Server: Receiving of Application Information of Credit Inspection

The credit organization server 210 receives application information of credit inspection 400 from the buyer client 230 through the communication network 250.

Alternatively, the credit organization server 210 may receive the application information of credit inspection 400 indirectly through another system or using a file instead of receiving directly from the buyer client 230 through the communication network 250.

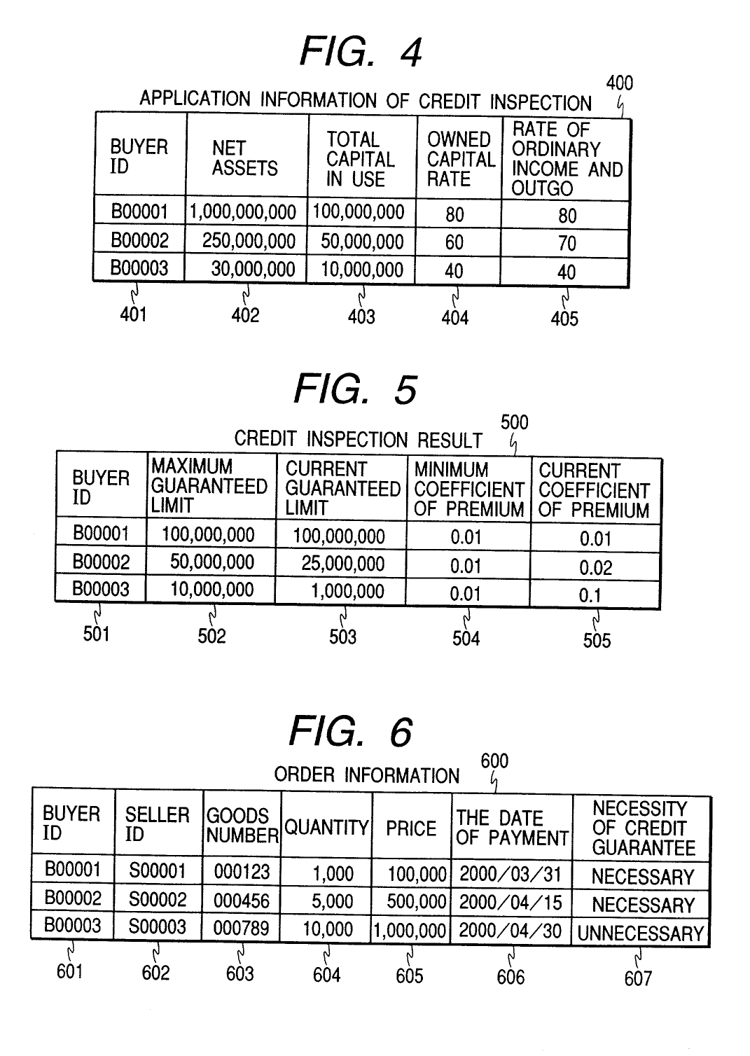

FIG. 4 shows an example of the received application information of credit inspection 400. The application information of credit inspection 400 is composed of a buyer ID field 401, a net assets field 402, a “total capital in use” field 403, an owned capital rate field 404, and a “rate of ordinary income and outgo” field 405.

<Step 112> Credit Organization Server: Credit inspection Process

Based on the application information of credit inspection 400 received at step 111, the credit organization server 210 performs a credit inspection process to evaluate the enterprise and determine the credit limit and the coefficient of the premium by using, for example, a scoring system described on pages 55 through 59 of a book entitled “Credit Rating and Risk Management” published by Ginko Kenshu-Sha on Nov. 4, 1997, mainly analyzing conventional financial figures and indices.

A scoring system is an enterprise evaluation system using a point system. Specifically, the scoring system gives points to each financial figure of a target enterprise, such as the assets scale, profit scale, and other various financial ratios, and then totals the given points to evaluate the enterprise.

FIG. 5 shows an example of credit inspection results 500. Each credit inspection result 500 is composed of a buyer ID field 501, a maximum guaranteed limit field 502, a current guaranteed limit field 503, a “minimum coefficient of premium” field 504, and a “current coefficient of premium” field 505.

It should be noted that the “minimum coefficient of premium” field 504 and the “current coefficient of premium” field 505 may not be used in the first embodiment.

<Step 113> Credit Organization Server: Sending of a Credit Inspection Result

The credit organization server 210 transmits a credit inspection result 500 obtained at step 112 to the buyer client 230 through the communication network 250.

Alternatively, the credit organization server 210 may transmit the credit inspection result 500 indirectly through another system or using a file instead of transmitting directly through the communication network 250.

Next, processing of an order is described.

<Step 121> Electronic Commerce Server: Receiving of Order Information

The electronic commerce server 220 receives order information 600 from the buyer client 230 through the communication network 250.

FIG. 6 shows an example of the received order information 600. The order information 600 is composed of a buyer ID field 601, a seller ID field 602, a goods (article) number field 603, a quantity field 604, a price field 605, a “date of payment” field 606, and a “necessity of credit guarantee” field 607.

<Step 122> Electronic Commerce Server: Determining whether a Credit Guarantee is Required

The electronic commerce server 220 checks whether the “necessity of credit guarantee” field 607 included in the order information 600 received at step 121 indicates “necessary” or “unnecessary”.

<Step 123> Electronic Commerce Server: Sending of a Credit Guarantee Request and Order Information

If the “necessity of credit guarantee” field 607 included in the order information 600 indicates “necessary” at step 122, the electronic commerce server 220 transmits to the credit organization server 210 the buyer ID field 601, the seller ID field 602, the price field 605, and the “date of payment” field 606 included in the order information 600, and a request for a credit guarantee.

<Step 114> Credit Organization Server: Receiving of a Credit Guarantee Request and Order Information

The credit organization server 210 receives the request for the credit guarantee and order information 600 and from the electronic commerce server 220 through the communication network 250.

<Step 115> Credit Organization Server: Credit Guarantee Process

A credit guarantee process 115 is described in detail below with reference to the detailed process flowchart shown in FIG. 3.

<Step 301> Credit Organization Server: Searching for a Credit Inspection Result of a Buyer That has Placed an Order for which a Credit Guarantee is Required

Based on the request for the credit guarantee and the order information and received at step 114, the credit organization server 210 searches the storage 212 for a credit inspection result 500 corresponding to the buyer ID indicated by the buyer ID field 601 included in the order information 600.

<Step 302> Credit Organization Server: Determining whether the Corresponding Credit Inspection Result Exists.

Based on the search result obtained at step 301, the credit organization server 210 determines whether there exists a credit inspection result 500 corresponding to the buyer ID indicated by the buyer ID field 601 included in the order information 600.

<Step 303> Credit Organization Server: Obtaining Application Information Of Credit Inspection

If it is determined that no corresponding credit inspection result 500 exists at step 302, the credit organization server 210 obtains the application information of credit inspection 400 from the buyer client 230 through the communication network 250.

Alternatively, the credit organization server 210 may obtain the application information of credit inspection 400 indirectly through another system or using a file instead of obtaining directly from the buyer client 230 through the communication network 250.

<Step 304> Credit Organization Server: Credit Inspection Process

The credit organization server 210 performs the above credit inspection process on the application information of credit inspection 400 obtained at step 303.

<Step 305> Checking Whether the Price Included in Order Information=the Current Guaranteed Limit Included in a Credit Inspection Result

If it is determined that the corresponding credit inspection result 500 exists at step 302, the credit organization server 210 compares the price field 605 included in the order information 600 with the current guaranteed limit included in the credit inspection result 500 which is retrieved at step 301 and which corresponds to the buyer ID indicated by the buyer ID field 601 included in the order information 600.

If it is determined that no corresponding credit inspection result 500 exists at step 302, the credit organization server 210 compares the price field 605 included in the order information 600 with the current guaranteed limit included in the credit inspection result 500 which is obtained at step 304 and which corresponds to the buyer ID indicated by the buyer ID field 601 included in the order information 600.

<Step 306> Setting the Value of the “Possibility of Credit Guarantee” Field to “Possible”

If it is determined from the comparison result at step 305 that the price indicated by the price field 605 included in the order information 600 is equal to or less than the current guaranteed limit included in the credit inspection result 500 corresponding to the buyer ID indicated by the buyer ID field 601 included in the order information 600, the credit organization server 210 prepares a credit guarantee result 700 and sets “possible” for its “possibility of credit guarantee” field 706.

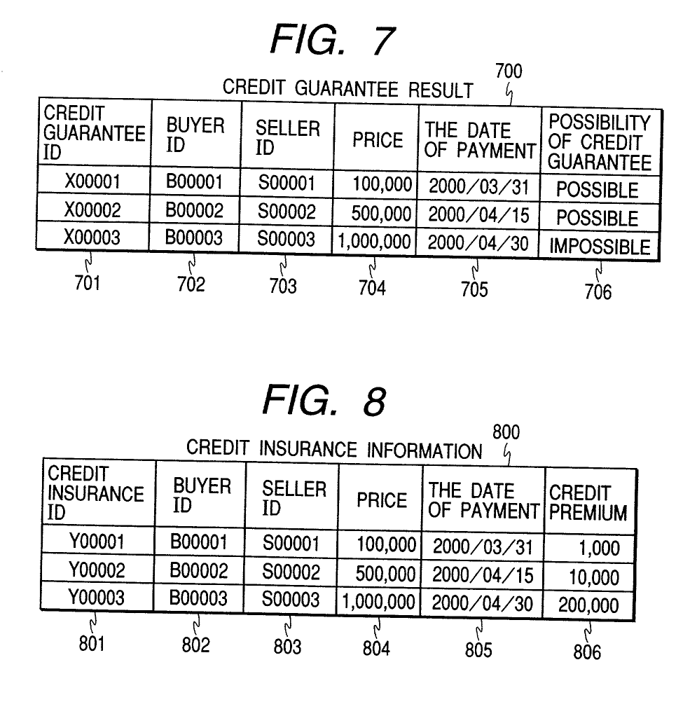

FIG. 7 shows an example of the credit guarantee results 700. Each credit guarantee result 700 is composed of a credit guarantee ID field 701, a buyer ID field 702, a seller ID field 703, a price field 704, a “date of payment” field 705, and a “possibility of credit guarantee” field 706.

<Step 307> Updating Credit Inspection Result

If it is determined from the comparison result at step 305 that the price indicated by the price field 605 included in the order information 600 is equal to or less than the current guaranteed limit included in the credit inspection result 500 corresponding to the buyer ID indicated by the buyer ID field 601 included in the order information 600, the credit organization server 210 updates the credit inspection result. Specifically, the credit organization server 210 subtracts the price indicated by the price field 605 included in the order information 600 from the current guaranteed limit field 503 included in the credit inspection result 500 corresponding to the buyer ID indicated by the buyer ID field 601 included in the order information 600.

<Step 308> Setting the Value of the “Possibility of Credit Guarantee” Field to “Impossible”

If it is determined from the comparison result at step 305 that the price indicated by the price field 605 included in the order information 600 is more than the current guaranteed limit included in the credit inspection result 500 corresponding to the buyer ID indicated by the buyer ID field 601 included in the order information 600, the credit organization server 210 prepares a credit guarantee result 700, and sets “impossible” for its “possibility of credit guarantee” field 706.

Referring back to FIG. 1, the process steps employed by the first embodiment will be further described.

<Step 116> Credit Organization Server: Sending of a Credit Guarantee Result

The credit organization server 210 transmits the credit guarantee result 700 to the electronic commerce server 220 through communication network 250.

<Step 124> Electronic Commerce Server: Receiving of a Credit Guarantee Result

The electronic commerce server 220 receives the credit guarantee result 700 from the credit organization server 210 through the communication network 250.

<Step 125> Electronic Commerce Server: Sending of order Information with a Credit Guarantee Result Attached Thereto

After receiving the credit guarantee result at step 124, or if the “necessity of credit guarantee” field 607 included in the order information 600 indicates “unnecessary” at step 122, the electronic commerce server 220 performs the following process. The electronic commerce server 220 transmits to the seller client 240 the order information 600 with the credit guarantee result 700 attached thereto through the communication network 250.

It should be noted that in the above case where the “necessity of credit guarantee” field 607 included in the order information 600 indicates “unnecessary” at step 122, the “possibility of credit guarantee” field 706 is set to unprocessed.

<Step 126> Electronic Commerce Server: Receiving of an Order Reception Result

The electronic commerce server 220 receives an order reception result from the seller client 240 through the communication network 250. The order reception result includes a credit guarantee ID and information indicating whether to accept or reject the corresponding order information.

<Step 127> Electronic Commerce Server: Sending of an Order Reception Result

The electronic commerce server 220 transmits the order reception result received at step 127 to the credit organization server 210 and the buyer client 230 through the communication network 250.

It should be noted that in the above case where the “necessity of credit guarantee” field 607 included in the order information 600 indicates “unnecessary” at step 122, the electronic commerce server 220 does not transmit the order reception result to the credit organization server 210.

<Step 117> Credit Organization Server: Receiving of an Order Reception Result

The credit organization server 210 receives the order reception result from the electronic commerce server 220 through the communication network 250. If the order reception result indicates “order accepted”, the record in the credit guarantee results 700 which includes the same credit guarantee ID as that included in the order reception result is set to be valid. It should be noted that the record may be registered in the credit guarantee results 700 at this time point instead of at the above step 115.

It should be further noted that this step 117 is omitted in the above case where the “necessity of credit guarantee” field 607 included in the order information 600 indicates “unnecessary” at step 122.

In the event of apparent nonpayment as to order information guaranteed by the credit organization server 210, the credit organization server 210 makes inquiries to the buyer client about the nonpayment after receiving a request for guaranteeing the payment from the seller. If the buyer client actually cannot pay for the order, the credit organization server 210 processes information to carry out the payment to the seller.

If no request for guaranteeing the payment is made for a predetermined period of time after the date of the payment, or if the credit organization server 210 receives the message “order rejected” as to order information guaranteed by the credit organization server 210 as an order reception result from the electronic commerce server 220, the credit organization server 210 updates the credit inspection result 500 so that the current guaranteed limit field 503 is set to a value up to the maximum guaranteed limit field 502. In this case, the record in the credit guarantee results 700 which includes the same credit guarantee ID as that included in the order reception result can be deleted.

According to the present embodiment as described above, a seller can receive an order to which a credit guarantee is attached beforehand, making it possible to reduce the cost for inspecting a new customer's credit standing and the cost for checking a customer's credit standing each time an order is received. Furthermore, the present embodiment ensures payment collections by sellers.

Regarding the timing at which to perform the credit inspection process, the following two aspects of the present embodiment can be considered.

(1) The credit inspection process is performed before the buyer client 230 transmits the first order information to the electronic commerce server 220.

(2) The credit inspection process is performed at the time when the buyer client 230 transmits the first order information to the electronic commerce server 220.

Further, regarding how to determine whether a credit guarantee is required, the following two aspects of the present embodiment can be considered.

(1) The determination is made based on the value (“necessary” or “unnecessary”) of the “necessity of credit guarantee” field 607 included in the order information 600 transmitted from the buyer client 230 to the electronic commerce server 220.

(2) The determination is made by the electronic commerce server 220 based on credit guarantee necessity conditions registered with the electronic commerce server 220 by the buyer client 230.

Still further, regarding how to determine whether to transmit the order information with a credit guarantee result attached thereto, the following two aspects of the present embodiment can be considered.

(1) The order information 600 with the credit guarantee result 700 attached thereto is unconditionally transmitted to the seller client 240.

(2) The electronic commerce server 220 determines whether to transmit to the seller client 240 the order information 600 with the credit guarantee result 700 attached thereto based on order information transmission conditions registered with the electronic commerce server 220 by the seller client 240 beforehand.

Next, a second embodiment of the present invention will be described.

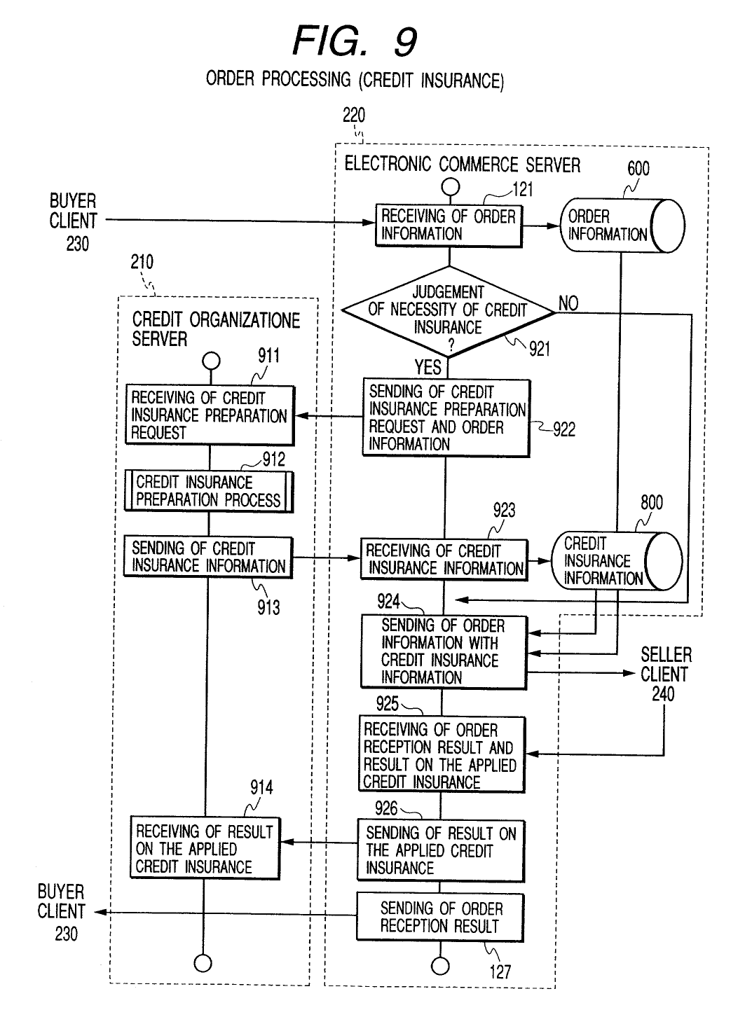

FIG. 9 is a flowchart showing the overall process for ensuring payment collection by a seller by use of a credit insurance according to a method of electronic credit service of the second embodiment.

FIG. 2 is a diagram showing the configuration of an electronic credit service system realizing the first and second embodiments. Since the system configuration shown in the figure was already described in the above first embodiment, the description is omitted this time.

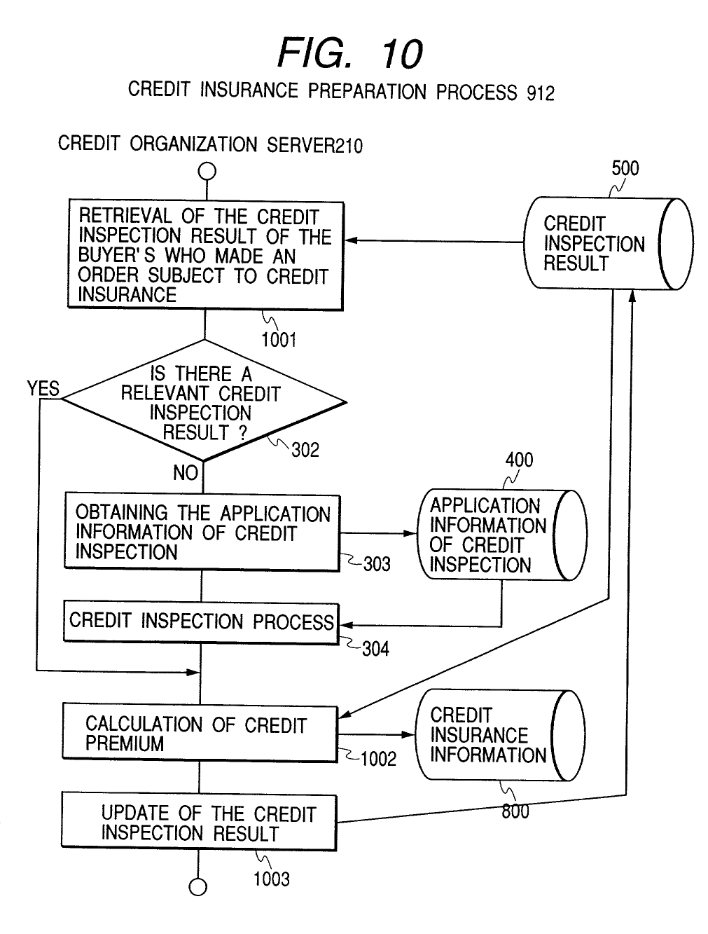

The process performed by the second embodiment is described with reference to the overall process flowchart in FIG. 9 and the detailed process flowchart in FIG. 10 along with FIG. 2.

<Step 121> Electronic Commerce Server: Receiving of Order Information

The electronic commerce server 220 receives order information 600 from the buyer client 230 through the communication network 250.

<Step 921> Electronic Commerce Server: Determining Whether a Credit Insurance is Required

For the order information received at step 121, the electronic commerce server 220 determines whether a credit insurance is required based on credit insurance necessity conditions registered by the seller client 240 beforehand.

The credit insurance necessity conditions include the conditions of buyers and a price range that require a credit insurance.

<Step 922> Electronic Commerce Server: Sending of a Credit Insurance Preparation Request and Order Information

If it is determined that a credit insurance is required at step 921, the electronic commerce server 220 transmits the buyer ID field 601, the seller ID field 602, the price field 605, and the “date of payment” field 606 included in the order information 600, and a request for preparation of a credit insurance to the credit organization server 210 through the communication network 250.

<Step 911> Credit Organization Server: Receiving of a Credit Insurance Preparation Request and Order Information

The credit organization server 210 receives the request for the preparation of the credit insurance and the order information 600 and from the electronic commerce server 220 through the communication network 250.

<Step 912> Credit Organization Server: Credit Insurance Preparation Process

A credit insurance preparation process 912 is described in detail below with reference to the detailed process flowchart shown in FIG. 10.

<Step 1001> Credit Organization Server: Searching for a Credit Inspection Result of a Buyer That has Placed an Order for Which a Credit Insurance is Required

Based on the request for the preparation of the credit insurance and the order information 600 received at step 911, the credit organization server 210 searches the storage 212 for a credit inspection result 500 corresponding to the buyer ID indicated by the buyer ID field 601 included in the order information 600.

<Step 302> Credit Organization Server: Determining Whether the Corresponding Credit Inspection Result Exists.

Based on the search result obtained at step 1001, the credit organization server 210 determines whether there exists a credit inspection result 500 corresponding to the buyer ID indicated by the buyer ID field 601 included in the order information 600.

<Step 303> Credit Organization Server: Obtaining Application Information of Credit Inspection

If it is determined that no corresponding credit inspection result 500 exists at step 302, the credit organization server 210 obtains the credit inspection application information 400 from the buyer client 230 through the communication network 250.

Alternatively, the credit organization server 210 may obtain the application information of credit inspection 400 indirectly through another system or using a file instead of obtaining directly from the buyer client 230 through the communication network 250.

<Step 304> Credit Organization Server: Credit Inspection Process

The credit organization server 210 performs the above credit inspection process on the application information of credit inspection 400 obtained at step 303.

FIG. 5 shows an example of credit inspection results 500. Each credit inspection result 500 is composed of a buyer ID field 501, a maximum guaranteed limit field 502, a current guaranteed limit field 503, a “minimum coefficient of premium” field 504, and a “current coefficient of premium” field 505.

It should be noted that the maximum guaranteed limit field 502 and the current guaranteed limit field 503 are not used in the second embodiment.

<Step 1002> Calculation of a Credit Premium

If it is determined that the corresponding credit inspection result 500 exists at step 302, the credit organization server 210 prepares credit insurance information 800 for the credit inspection result 500 which is retrieved at step 1001 and which corresponds to the buyer ID indicated by the buyer ID field 601 included in the order information 600, and sets a value for its credit premium field 806. If it is determined that no corresponding credit inspection result 500 exists at step 302, on the other hand, the credit organization server 210 prepares the credit insurance information 800 for the credit inspection result 500 which is obtained at step 304 and which corresponds to the buyer ID indicated by the buyer ID field 601 included in the order information 600, and sets a value for its credit premium field 806. The credit premium 806 is calculated by, for example, multiplying the price indicated by the price field 605 included in the order information 600 with the value indicated by the “current coefficient of premium” field 505 included in the credit inspection result 500 corresponding to the buyer ID indicated by the buyer ID field 601 included in the order information 600.

FIG. 8 shows an example of credit insurance information 800. The credit insurance information 800 is composed of a credit insurance ID field 801, a buyer ID field 802, a seller ID field 803, a price field 804, a “date of payment” field 805, and a credit premium field 806.

<Step 1003> Updating Credit Inspection Result

The credit organization server 210 updates the credit inspection results 500 based on the credit premium 806 calculated at step 1002. Specifically, the credit organization server 210 increases the value of the “current coefficient of premium” field 505.

Referring back to FIG. 9, the process steps employed by the second embodiment will be further described.

<Step 913> Credit Organization Server: Sending of credit Insurance Information

The credit organization server 210 transmits credit insurance information 800 to the electronic commerce server 220 through the communication network 250.

<Step 923> Electronic Commerce Server: Receiving of Credit Insurance Information

The electronic commerce server 220 receives the credit insurance information 800 from the credit organization server 210 through the communication network 250.

<Step 924> Electronic Commerce Server: Sending of order Information with Credit Insurance Information Attached Thereto

After receiving the credit insurance information at step 923, or if it is determined that no credit insurance is required at step 921, the electronic commerce server 220 transmits to the seller client 240 the order information 600 with the credit insurance information 800 attached thereto through the communication network 250.

It should be noted that in the above case where it is determined that no credit insurance is required at step 921, the credit premium field 806 included in the credit insurance information 800 has no entry.

<Step 925> Electronic Commerce Server: Receiving of an Order Reception Result and a Credit Insurance Application Result

The electronic commerce server 220 receives an order reception result and a credit insurance application result from the seller client 240 through the communication network 250. The order reception result includes information indicating whether the seller client 240 accepts or rejects the order information. The credit insurance application result, on the other hand, includes information indicating whether the seller client 240 applies for the credit insurance.

<Step 926> Electronic Commerce Server: Sending of a Credit Insurance Application Result

The electronic commerce server 220 transmits the credit insurance application result received at step 925 to the credit organization server 210 through the communication network 250.

However, if it is determined that no credit insurance is required at step 921, this step 926 is omitted.

<Step 914> Credit Organization Server: Receiving of a Credit Insurance Application Result

The credit organization server 210 receives the credit insurance application result from the electronic commerce server 220 through the communication network 250. If the received credit insurance application result indicates “application requested”, the credit organization server 210 validates the record in the credit insurance information 800 which has the same credit insurance ID as that included in the received credit insurance application result. It should be noted that the record may be registered in the credit insurance information 800 at this time point instead of at the above step 912.

It should be further noted that this step 914 is omitted if it is determined that no credit insurance is required at step 921.

<Step 127> Electronic Commerce Server: Sending of an Order Reception Result

The electronic commerce server 220 transmits the order reception result received at step 925 to the buyer client 230 through the communication network 250.

In the event of apparent nonpayment as to order information for which a credit insurance application has been made, the credit organization server 210 makes inquiries to the buyer client about the nonpayment after receiving a request for guaranteeing the payment from the seller. If the buyer client actually cannot pay for the order, the credit organization server 210 processes information to carry out the payment to the seller.

If no request for guaranteeing the payment was made for a predetermined period of time after the date of the payment, or if the credit organization server 210 has received a credit insurance application result indicating “application not requested” from the electronic commerce server 220, the credit organization server 210 updates the credit inspection result 500 so that the “minimum coefficient of premium” field 504 is set to a value up to the “current coefficient of premium” field 505. In this case, the record in the credit insurance information 800 which includes the same credit insurance ID as that included in the credit insurance application result can be deleted.

According to the present embodiment as described above, a seller can receive an order to which a credit insurance is attached beforehand, making it possible to reduce the cost for inspecting a new customer's credit standing and the cost for checking a customer's credit standing each time an order is received. Furthermore, the present embodiment can ensures payment collections by sellers.

Regarding the timing at which to perform the credit inspection process, the following two aspects of the present embodiment can be considered.

(1) The credit inspection process is performed at the time when the buyer client 230 transmits the first order information to the electronic commerce server 220.

(2) The credit inspection process is performed before the buyer client 230 transmits the first order information to the electronic commerce server 220.

Further, regarding how to determine whether a credit insurance is required, the following two aspects of the present embodiment can be considered.

(1) The determination is made based on credit insurance necessity conditions registered with the electronic commerce server 220 by the seller client 240.

(2) The order information 600 is transmitted from the electronic commerce server 220 to the seller client 240, and then the seller client 240 determines whether a credit insurance is required for each order.

In FIG. 2, which was used to describe the above two embodiments of the present invention, the credit organization server and the electronic commerce server are provided separately. However, these two server functions may be implemented by a single server, providing a system configuration consisting of three players: a credit organization/electronic commerce server, a buyer client, and a seller client.

Even though FIG. 2 only shows one credit organization server, one electronic commerce server, one buyer client, and one seller client, it goes without saying that there actually exist a plurality of buyer clients and a plurality of seller clients. Furthermore, the system may be configured such that there exist a plurality of credit organization servers and a plurality of electronic commerce servers linked to one another for providing service.

What is claimed is:

1. A method of providing electronic credit service using an electronic credit system which includes:
a credit organization apparatus storing information on solvency of individuals or groups;
a buyer apparatus for ordering goods or service;
a seller apparatus for providing the goods or the service ordered by said buyer apparatus; and
an electronic commerce apparatus for processing information to mediate a transaction between said buyer apparatus and said seller apparatus;
wherein said credit organization apparatus, said buyer apparatus, said seller apparatus, and said electronic commerce apparatus are connected to one another through a communications network;
said method comprising the steps of:
(a) transmitting application information of credit inspection inquiring about solvency of a user of said buyer apparatus to said credit organization apparatus through said communications network, and transmitting order information indicating an order for said transaction to said electronic commerce apparatus through said communications network, this step (a) being performed by said buyer apparatus;
(b) calculating credit inspection information indicating the solvency of said user based on information on the solvency of said user stored beforehand and said application information of credit inspection, and transmitting the calculated credit inspection information to said electronic commerce apparatus through said communications network, this step (b) being performed by said credit organization apparatus; and
(c) determining whether said user of said buyer apparatus is capable of paying a price of the transaction ordered by said order information based on said credit inspection information, and if it is determined that said user is capable of paying said price, transmitting information corresponding to said order information to said seller apparatus through said communications network, this step (c) being performed by said electronic commerce apparatus.

2. A method of providing electronic credit service using an electronic credit system which includes:
a credit organization apparatus storing information on solvency of individuals or groups; and
a buyer apparatus for ordering goods or service;
a seller apparatus for providing the goods or the service ordered by said buyer apparatus;
wherein said credit organization apparatus, said buyer apparatus, and said seller apparatus are connected to one another through a communications network;
said method comprising the steps of:
(a) transmitting application information of credit inspection inquiring about solvency of a user of said buyer apparatus to said credit organization apparatus through said communications network, this step (a) being performed by said buyer apparatus;
(b) calculating credit inspection information indicating the solvency of said user based on information on the solvency of said user stored beforehand and said application information of credit inspection, and transmitting the calculated credit inspection information to said buyer apparatus through said communications network, this step (b) being performed by said credit organization apparatus; and
(c) transmitting said credit inspection information and order information indicating an order for goods or service to said seller apparatus through said communications network in order to order said goods or said service, this step (c) being performed by said buyer apparatus.

3. The method of providing electronic credit service as claimed in claim 2, wherein said electronic credit system further includes an electronic commerce apparatus for mediating said order, said electronic commerce apparatus being connected to said network; said buyer apparatus transmits said order information and said credit inspection information to said seller apparatus through said network; and based on said credit inspection information, said electronic commerce apparatus determines whether said user is capable of paying a price of the goods or the service ordered by said order information, and if said user is capable of paying said price, said electronic commerce apparatus transmits information corresponding to said order information to said seller apparatus.

4. The method of providing electronic credit service as claimed in claim 2, wherein said buyer apparatus transmits said credit inspection information with information attached thereto which indicates that said credit inspection information was transmitted from said credit organization apparatus.

5. An electronic commerce apparatus connected through a communications network to a credit organization apparatus, a buyer apparatus, and a seller apparatus, wherein said credit organization apparatus stores information on solvency of individuals or groups; said buyer apparatus orders goods or service; said seller apparatus provides the goods or the service ordered by said buyer apparatus; and said electronic commerce apparatus processes information to mediate a transaction between said buyer apparatus and said seller apparatus; said electronic commerce apparatus comprising:
means for receiving credit inspection information which indicates solvency of a user and which is calculated based on information on the solvency of said user stored beforehand and application information of credit inspection transmitted by said buyer apparatus, said credit inspection information being transmitted from said credit organization apparatus through said communications network;
means for receiving order information indicating an order for said transaction, said order information being transmitted from said buyer apparatus through said communications network;
means for, based on said credit inspection information, determining whether said user is capable of paying a price of the transaction ordered by said order information; and
means for, if said user is capable of paying said price, transmitting information corresponding to said order information to said seller apparatus through said communications network.

6. A method of providing electronic credit service for requesting a credit organization computer to give a buyer a credit guarantee when an electronic commerce computer receives order information from a computer of said buyer, stores said received order information in a storage means, and transmits said received order information to a computer of a seller, said method comprising the steps of:
(a) transmitting an identifier of said buyer and a price included in said order information from said electronic commerce computer to said credit organization computer to inquire whether said buyer can be given the credit guarantee;
(b) comparing said price received by said credit organization computer with a credit limit of said buyer to determine whether said buyer can be given the credit guarantee, and notifying said electronic commerce computer of the credit guarantee result;
(c) when said electronic commerce computer has received from said computer of said seller a notification of acceptance of an order indicated by said order information after said electronic commerce computer notified said computer of said seller of said credit guarantee result, notifying said credit organization computer of the acceptance of the order; and
(d) validating the credit guarantee result by use of said credit organization computer.

7. A method of providing electronic credit service performed by an electronic commerce computer to request a credit organization computer to give a buyer a credit guarantee when said electronic commerce computer receives order information from a computer of said buyer, stores said received order information in a storage means, and transmits said received order information to a computer of a seller, said method comprising the steps of:
(a) transmitting an identifier of said buyer and a price included in said order information to said credit organization computer to inquire whether said buyer can be given the credit guarantee;
(b) receiving from said credit organization computer a credit guarantee result indicating whether said buyer can be given the credit guarantee, and notifying said computer of said seller of the received credit guarantee result; and
(c) upon receiving from said computer of said seller a notification of acceptance of an order indicated by said order information, notifying said credit organization computer of the acceptance of the order to validate said credit guarantee result.

8. A method of providing electronic credit service for requesting a credit organization to issue a credit insurance for order information when an electronic commerce computer receives said order information from a computer of a buyer, stores said received order information in a storage means, and transmits said received order information to a computer of a seller, said method comprising the steps of:
(a) transmitting an identifier of said buyer and a price included in said order information to said credit organization computer to request credit insurance information on said order information, this step (a) being performed by said electronic commerce computer;
(b) calculating a credit premium corresponding to said price received by said credit organization computer, and notifying said electronic commerce computer of the credit insurance information including said credit premium;
(c) when said electronic commerce computer has received from said computer of said seller a notification of an application for a credit insurance after said electronic commerce computer notified said computer of said seller of said credit insurance information, notifying said credit organization computer of the application for the credit insurance; and
(d) validating the credit insurance information by use of said credit organization computer.

9. A method of providing electronic credit service performed by an electronic commerce computer to request a credit organization computer to issue a credit insurance for order information when said electronic commerce computer receives said order information from a computer of a buyer, stores said received order information in a storage means, and transmits said received order information to a computer of a seller, said method comprising the steps of:
(a) transmitting an identifier of said buyer and a price included in said order information to said credit organization computer to request credit insurance information on said order information;
(b) receiving from said credit organization computer the credit insurance information including a credit premium corresponding to said price, and notifying said computer of said seller of the received credit insurance information; and
(c) upon receiving from said computer of said seller a notification of an application for a credit insurance, notifying said credit organization computer of the application for the credit insurance to validate said credit insurance information.

10. A method of providing electronic credit service performed by a credit organization computer to give a buyer a credit guarantee in response to a request from an electronic commerce computer which receives order information from a computer of said buyer and transmits said received order information to a computer of a seller, said method comprising the steps of:
(a) receiving a credit guarantee request and an identifier of said buyer and a price included in said order information from said electronic commerce computer;
(b) comparing said price with a credit limit of said buyer to determine whether said buyer can be given the credit guarantee;
(c) notifying said electronic commerce computer of credit guarantee result; and
(d) when receiving a notification of acceptance of an order indicated by said order information from said seller through said electronic commerce computer, validating the credit guarantee result.

11. A method of providing electronic credit service performed by a credit organization computer to prepare a credit insurance for a buyer in response to a request from an electronic commerce computer which receives order information from a computer of said buyer and transmits said received order information to a computer of a seller, said method comprising the steps of:
(a) receiving a request for a credit insurance information on said order information and an identifier of said buyer and a price included in said order information from said electronic commerce computer;
(b) calculating a credit premium corresponding to said price;
(c) notifying said electronic commerce computer of the credit insurance information including said credit premium; and
(d) when receiving a notification of the application for the credit insurance from said seller through said electronic commerce computer, validating the credit insurance information.
